(19) United States
(12) Patent Application Publication
(10) Pub. No.: US 2012/0226659 A1
(43) Pub. Date: Sep. 6, 2012

(54) SYSTEM AND METHOD FOR MONITORING ELEMENTS AND CATEGORIZING USERS WITHIN A NETWORK

(76) Inventors: Derek Ball, Calgary (CA); Dayton Foster, Calgary (CA)

(21) Appl. No.: 13/365,195

(22) Filed: Feb. 2, 2012

Related U.S. Application Data
(60) Provisional application No. 61/438,718, filed on Feb. 2, 2011.
(60) Provisional application No. 61/473,804, filed on Apr. 10, 2011.

(51) Int. Cl. G06F 17/30

(52) U.S. Cl. 707/609; 707/E17.005

(57) ABSTRACT

Systems and methods for monitoring user interactions with keywords associated with a brand or words and phrases within the brand, present within a network resource and for enhancing user experience related to access of a network resource are described. A first computing device maintains a network resource and provides the resource and an agent to a second computing device. The agent monitors user interactions with the network resource when the network resource is displayed on the second computing device. The user interactions include implicit interaction.

### CROSS-REFERENCE TO RELATED APPLICATIONS

The present application claims priority from U.S. Provisional Patent Application No. 61/438,718 filed Feb. 2, 2011, and from U.S. Provisional Patent Application No. 61/473,804 filed Apr. 10, 2011, which are expressly incorporated by reference herein for all purposes.

### FIELD OF THE INVENTION

The present invention relates generally to network computing and more particularly to network resource content management.

### BACKGROUND OF THE INVENTION

All of the publications, patents and patent applications cited within this application are herein incorporated by reference in their entirety to the same extent as if the disclosure of each individual publication, patent application or patent was specifically and individually indicated to be incorporated by reference in its entirety.

In recent years the popularity of computing devices, and the communication networks established between these computing devices, have increased dramatically. Such communications networks allow computing device users, either in a business, government or personal setting, to communicate with each other, either through a centralized communication point, through a plurality of distributed and redundant communication points, or directly. This allows exchange of information between the computing devices on the communication network, using a common communication protocol between them. It is common for corporations or business to establish a common communications network between their computing devices, otherwise referred to as “intranets”, in which the communication network has limited or no access to unauthorized persons and/or computing devices. It is common for intranets to be protected by security systems, such as firewalls, which prevent access by unauthorized users of the communications network, the computing devices communicating through it, and the information contained within these computing devices.

The term “Internet” has been adopted to describe the publicly available network which has nearly worldwide coverage, and to which most personal computing devices have access. The pervasive nature of the Internet, combined with the lower cost and increased performance of personal computing devices, has led to it being a popular source of information. Systems are available which provide an individual with the ability to search for information or resources within the Internet. For example, systems exist which allow a user to search for information stored on other Internet computing devices (e.g., servers), thus providing generalized access to these resources. When an individual is searching for specific information, however, the resource on the Internet may not provide the specific information desired by the individual, or else it may provide certain information in an undesired context. The individual may then continue searching, or else use an alternate system to perform the required searching activities. In general, these searching systems provide minimal ability for a user to provide feedback as to the success of the search, or ways for the user to refine future searches. Generally, the user establishes a series of search terms to initiate a search, and upon failure of the search results to provide the user with what he is looking for, the user modifies or adds further search terms in an effort to increase the chance of success on the next search. Alternatively, the user may switch to an alternate search system and attempt to obtain a successful search result using that second system.

Computing devices communicate within a network using a common set of standards for exchanging data. One common example is the Transmission Control Protocol/Internet Protocol (TCP/IP) suite. To initiate communications within the communication network, a user (client) may contact another computing device on the network (server) and request information or a resource. This is facilitated by various software and hardware systems generally available. A user can access resources within the Internet by being directed through software (e.g., by clicking a hyperlink), by entering a Universal Resource Locator (URL), etc.

A popular protocol for organizing and sharing information on the Internet via the client/server model is known as the HyperText Transfer Protocol (HTTP), and is more commonly referred to in a general sense as the World Wide Web (the web). Generally, the web links information by associating items of interest through the use of HyperText Markup Language (HTML) files, which reside on servers and usually are transferred to clients via HTTP. A user of the web may traverse it by receiving and viewing an HTML file (or just an image, video, etc.), which may contain within it information or embedded images, but which also may contain information on how to acquire further resources from the web, by, for example, incorporating URLs within the file. This information may be displayed to a user as a combination of text and media (for example images, sound, video) and generally is referred to as a “page” or “web page.”

No central authority exists for cataloguing the hundreds of millions of network resources, such as HTML pages, files or media available within an intranet or the Internet. In general though, there are two approaches taken for finding information or resources of interest within a network: 1) a directory hierarchy and 2) a search engine. Within a directory hierarchy a web page may be analyzed and categorized, allowing users to scan through various categories, and associated subcategories, to identify resources of interest. Alternatively, a search engine may provide a dataset of terms and phrases (keywords) upon which a user may query, and may return a listing of web resources associated with the keywords. Many such search engines are known in the art, with examples including, but not limited to, Google®, Yahoo® and Alta Vista®. Yet the analyzing and categorizing of web pages is a very resource and time intensive task, one further complicated by the dynamic nature of web pages being created, modified and deleted by the publishers or managers of the web pages. For parties without the resources and computing facilities of the large search engines, understanding the content of a given page can be a challenge.

Generally, the user employs a client, which may be a web browser, to interact with the web and the various files found on it (e.g., HTML, audio and video files, etc.). The browser may be implemented through execution of a program operating on a computing device, such as a personal computing device, cellular telephone or other mobile device.

Computing devices are typically capable of multi-tasking, and further provide a variety of user interfaces for controlling various and multiple application programs or system functions simultaneously operating in the computing device environment. Personal Computing devices (“PC”) are particularly commonplace, operating with an operating system (“OS”) capable of multi-tasking such as Microsoft Windows™ or Apple Computing device's MacOS™, or LINUX™. Smaller computing platforms such as held-held computing devices, personal digital assistants (“PDA”), and advanced wireless telephones may run operating systems capable of multitasking as well.

Users often wish to copy or transfer information or “content” from one program or system function within an OS environment, to another. Using “copy and paste” functions of the application programs and the operating system, the user may select information from a source program (e.g. a Web Browser receiving and displaying information received over an Internet), and “paste” it into the destination program (e.g. a text editing program or document creation program).

A further issue in the art is identifying trends within the population, in general, and users of a network in particular. Judging the efficacy of advertising with a goal to increase brand recognition, rather than specific sales of a product or service, or conversions of a user viewing an advertisement provided by virtue of the user's accessing a resource within a network, can be very difficult. The art is in need of means to measure effectiveness of brand advertising campaigns or general increase or decrease in brand awareness. As well, derivation of opinions or attitudes towards the brands is valuable information for the brand owners, managers or third parties monitoring the brands.

Monitoring of the many data sources and data streams available within broad networks, such as an Internet, can be a complex and expensive process. There are a number of disparate data sources capable of being screened for the presence of keywords associated with a brand or words and phrases within a brand, using means known in the art. Such data sources include social media data streams for all users or a subpopulation thereof (where the subpopulation can be defined by geography, demographics, or time), users sharing the URL of a network resource with others through social media or through electing to communicate the URL to third party servers which aggregate such data for communication to a population of users (for example, “Digg.com” and other similar organizations), or through other means of user's communicating through a network such as blog postings, emails or messaging services. The limitation of the current art is that the data streams result from the explicit election of a user to share or communicate an interest in a network resource, brand, commodity or service; and only a small percentage of total user's engage in.

### SUMMARY OF THE INVENTION

With respect to the accessing of information through a network, for example an Internet, it is a problem in the present state of the art that people who publish content (text, images, audio, etc.) accessible within a network can easily have their content copied without their knowledge or authorization. The very functionality of the copy and paste within an OS make this easy in the digital world. Industry observers sometimes refer to this as ‘atomization’ of content. But this very same atomization of content provides the opportunity to gain valuable insight into the implicit interactions of users accessing network resources. The present art has suffered from restricted ability to accumulate information relating to keywords associated with a brand or words and phrases within a brand.

In one aspect, the present invention provides a method for monitoring of user interactions with keywords associated with a brand or words and phrases within the brand, present within a network resource comprising execution of a software application operating within the software environment of a viewing program operating on a user computing device, the viewing program capable of viewing resources available in a network (a “network resource”), the software application identifying the user electing to undertake implicit user interactions with elements within the network resource, wherein the element subject to an implicit user interaction within the network resource is communicated to a party other than the user and wherein the element subject to an implicit user interaction from the network resource is analyzed for the presence of keywords associated with a brand or words and phrases within the brand. In a further embodiment the party other than the user has additional information communicated concurrently such information selected from the group comprising the URL of the network resource, the title of the network resource, meta tags associated with the network resource, and any additional information included in an URL including that arising from a search engine referral or redirect. In a still further embodiment, any hyperlinks followed, or advertising interacted with, is communicated to the party.

In another aspect, the present invention provides a system for monitoring of user interactions with keywords associated with a brand or words and phrases within the brand, present within a network resource comprising a first computing device in electronic communication with a network and a second computing device in electronic communication with a network. In certain embodiments, the network resource resides on the first computing device. In certain embodiments, the network resource is received by the second computing device and communicated to a user of the second computing device by a viewing program. In certain embodiments, the network resource causes the viewing program to access and execute software code which identifies an implicit user interaction with elements of the network resource. In certain embodiments, when a user elects to undertake an implicit user interaction with elements within the network resource the element subject to an implicit user interaction is communicated to a third computing device or to the first computing device. In certain embodiments, the element subject to an implicit user interaction within the network resource is analyzed for the presence of keywords associated with a brand or words and phrases within the brand.

In certain embodiments the third computing device has additional information communicated concurrently such information selected from the group comprising the URL of the network resource, the title of the network resource, meta tags associated with the network resource, and any additional information included in an URL arising from a search engine referral or redirect. In certain embodiments, any hyperlinks followed, or advertising interacted with, is communicated to the third computing device.

### BRIEF DESCRIPTION OF THE FIGURES

FIG. 1 shows a schematic illustrating communications flow for a user computing device running user interaction detection client software, a server and a network.

FIG. 2 illustrates delivery of user interaction detection software to the user computing device.

FIG. 3 shows a schematic of the communications flow between the Network Resource Provider, user client software and a server according to certain aspects of the invention.

FIG. 4 is a block diagram showing aspects a computing system employed according to certain aspects of the invention.

### DETAILED DESCRIPTION OF THE PRESENT INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. For example, the descriptions below may refer to interactions between computing devices and it will be appreciated that the term computing device can be taken to mean any suitable computing device such as servers, desktop computing devices, laptop computing devices, intelligent user devices such as cell-phones, PDAs, set-top boxes, game players and smart phones, etc. Moreover, applicants do not intend for any term in the specification or claims to be ascribed an uncommon or special meaning unless explicitly set forth as such. Further, the present invention encompasses present and future known equivalents to the components referred to herein by way of illustration.

Certain embodiments of the invention comprise methods and systems for monitoring user interactions with keywords associated with a brand or words and phrases within the brand, present within a network resource. As used herein, “computing device” may mean a device having a processor, a memory, and an operating system, capable of interaction with a user or other computing device, and shall include without limitation desktop computing devices, notebook computing devices, tablet computing devices, personal digital assistants (PDAs), servers, handheld computing devices, and mobile or cellular phones capable of satisfying the requirements of the present definition and similar devices. Though the present invention is explicitly contemplated not to be limited to any particular programming language, the JavaScript™ programming language is highly prevalent in many commercially available Internet browsers, and therefore represents a preferred implementation of the present invention.

Certain embodiments comprise software modules that are communicated by a first computing device to a second computing device and proximate in time, or concurrent with, the communication to the second computing device of a network resource located on the first computing device, typically using a network such as the Internet, a WAN, LAN or wireless network or other suitable network. In one example, a web page may be communicated as the network resource or part of the network resource comprising digital content. The module may comprise one or more functional elements as described further herein.

The module may comprise instructions and data that when executed or otherwise followed and used by the second computing device, typically proximate in time with the display of the network resource on the first computing device, may cause the first computing device to perform a copy command intercept on the first computing device. The copy command intercept may interact with the network resource viewer such as a web browser or other suitable viewing software (hereinafter, a browser) in order to detect certain actions by a user of the first computing device within the browser or a related application. The actions by the user may include copying of elements within the network resource, printing of the network resource, selecting elements within a network resource, or copying the URL of the network resource (referred to herein as an “implicit user interaction”). An implicit user interaction may be any activity of the user that enables identification of content, a portion of content, control, link and potential action or an interest of the user in the content but is not yet associated with an affirmative action by the user to select, copy, paste, activate, navigate to another resource, etc., based on the content or control, etc. For example, a user may cause a mouse to pas or hover over a link, which action may be a prerequisite for selecting the link and may therefore be regarded as an implicit action where an inference can be made that the user will, at some proximate point, select the link.

In another example, a copy command selected by the user (a “copy event”) may be an implicit interaction in that it may be inferred that the user will paste copied text into a search window, or into another document, for example. The copy command intercept program may cause the elements selected for copying to be transmitted into the a copy and paste memory buffer of the second computing device, optionally with additional content appended into the memory buffer such additional content being defined by a manager or administrator of the first computing device. A copy and paste process employed in certain embodiments is described more fully in U.S. patent application Ser. No. 12/192,391 (Pub. No. 20080300859), incorporated by reference, in its entirety, including figures, to the present patent application.

The copy command intercept module may report implicit user interactions to at least one other computing device in network communication with the second computing device, the information stored in a database for analysis, such information comprising what the copied content was or what elements were subject to an implicit user interaction, the URL of the original article, the IP address/geographic location of the browser doing the copying, the title of the network resource, meta tags associated with the network resource, any additional information included in an URL including that arising from a search engine referral or redirect, if a copy event whether the total length (as measured in words) of the copy was below a certain threshold length, or other information generally known in the art as useful for identifying relevance of information to a user. In one example, the threshold length may be 7 words.

When the user accesses the network resource by following a hyperlink generated as part of the optional appending of additional information as part of a copy event, this information may be included in the additional information included in an URL including that arising from a search engine referral or redirect. It may therefore be reported to at least one computing device in network communication with the second computing device. Additionally, information related to the following of hyperlinks and/or interaction with advertising, is communicated to at least one computing device in network communication with the second computing device.

In some embodiments, the additional content may be pasted with content subject to a copy event that is pasted by the use. Content may be directed to a memory resident on at least one other computing device in network communication with the second computing device for further processing, including analysis for the presence of certain keywords associated with a brand or words and phrases within the brand, present within a network resource as well as the presence of other words which may assist in the determination of sentiment with respect to the brand.

In certain embodiments a module may be communicated proximate in time, or concurrent with, the communication to the second computing device of a network resource located on the first computing device. The network resource may be a web page, for example. The module may include one or more functional elements and may operate as an agent. Certain functional elements of the module may be executed proximate in time to the network resource display on the first computing device using a browser or other application. A copy command intercept program on the first computing device may interact with the browser or other application and may be configured to detect certain actions by a user within the browser, or one or more related applications. The detected actions may comprise implicit user interactions including copying of elements within the network resource, printing of the network resource, selecting elements within a network resource, or copying the URL of the network resource, thereby creating an implicit user interaction.

When a copy command is selected by the user the copy command intercept program may cause the elements selected for copying to be transmitted into the user's copy/paste memory buffer of the second computing device, optionally with additional content appended into the memory buffer such additional content being defined by a manager or administrator of the first computing device. The copy command intercept component may report information related to the implicit user interactions to at least one other computing device in network communication with the second computing device. The information may be stored in a database for analysis, and the information may comprise the copied content, information defining the nature of the copied content, the elements that were subject to an implicit user interaction, the URL of the original article, the IP address/geographic location of the browser doing the copying, the title of the network resource, meta tags associated with the network resource, any additional information included in an URL including that arising from a search engine referral or redirect, if a copy event whether the total length (as measured in words) of the copy was below a certain threshold length, or other information generally known in the art as useful for identifying relevance of information to a user. In one example, the threshold length is 7 words.

When the user accesses the network resource by following a hyperlink generated as part of the optional appending of additional information as part of a copy event, this information may be included in the additional information included in an URL including that arising from a search engine referral or redirect, and is therefore reported to at least one computing device in network communication with the second computing device. Additionally any hyperlinks followed, or advertising interacted with, may be communicated to the at least one computing device in network communication with the second computing device. When the user pastes the content subject to a copy event, the additional content may be pasted as well.

Content may be directed to a memory resident on at least one other computing device in network communication with the second computing device for analysis for the presence of certain keywords associated with a brand or words and phrases within the brand, present within a network resource as well as the presence of other words which may assist in the determination of sentiment with respect to the brand.

### User Experience

Aspects of the present application may relate to n embodiment having a first user accessing a network resource using a network, such as the Internet or an Intranet, a second user, and a network resource administrator, such as a website administrator, who receives information on the content viewed and/or copied by the first user. In the example of a copy-event, the first user may decide to copy content from a network resource, such as a web page, while viewing a network resource. The user selects, for example, [control C] or Apple C or right clicks and selects the ‘copy’ command, or chooses Copy from the main menu. The user then pastes the content into a document such as word processing, email, note pad, etc. The original selected content may be pasted with additional information as specified by the owner of the site being from which the content is copied. An example of this additional information is a link back to the original article and some attribution text. An example of this might be:

[Content for which Copying is Requested]

South Africa's problems, along with other factors like rising crime and relatively low pay, are pushing many physicians out. Some, like Dr. Craig Laurence, feel Canada's pull. In March, Laurence

### [Additional Information]

Click here to read the original article at http://www.calgaryherald.com/Alberta+bound+South+African+doctors+coming+Canada/1063582/story.html#ixzz0QvJ417Nx

The Calgary Herald—Calgary's Best Source For News!

The additional information element ‘#ixzz0QvJ417Nx’ represents a unique generated ID which may be generated when the content is copied. The unique ID may be combined with the module or agent (as described herein) on the user computing device, which may permit the highlighting of copied content when the URL present in the additional information is accessed. This may be enabled by way of communication of the unique generated ID by the module or agent operating on the user computing device to a computing device in network communication with it. The module or agent may communicate the unique ID to a second computing device using a network and the second computing device, which had received and stored the unique ID along with the content copied by the first user when the first user undertook the copy action, retrieves the content copied by the first user and communicates this to the second computing device.

The module or agent may then modify the network resource displayed to the second user so as to identify the original content copied by the first user, for example by highlighting the originally copied content. Using the unique ID to identify which portion of the network resource was originally copied (such event generating the unique ID), the module or agent may receive this information and then apply a highlighting or other format change to that element.

A second User using the link optionally included in the additional information may observe that the web page loads with the copied content highlighted for the user to see the context. A second computing device receiving data related to implicit user interactions and copy events (an “analysis database”), may be capable of collecting information relating to a user's implicit interactions with elements contained within network resources present within a network and is therefore capable of assessing user's engagement with keywords associated with a brand or words and phrases within the brand. Certain aspects of the present invention provide a significant improvement over the prior art in that it captures user engagement without the user having to take explicit steps to share or communicate the engagement with a network resource (by way of non-limiting example “liking” the resource through social media or otherwise sharing the existence of the network resource with a collection of users). As the analysis is performed on implicit interactions, it is anticipated that the population of users providing data will be much larger that those choosing to explicitly share or communicate engagement with a network resource; and therefore the data collected by the analysis database larger. This is may lead to significantly faster analysis of trends associated with brands or keywords and phrases associated with brands, to the benefit of the brand owners, brand managers or third parties interested in brand engagement.

The effectiveness of an advertising campaign directed to increasing brand awareness can be very difficult to gauge. Since there is no specific conversion activity sought as part of the advertising process, for example the purchase of wares or services by the consumer or party receiving the advertising; increase in sales activity is a poor and occasionally inappropriate surrogate for effectiveness of such an advertising campaign. With the advent of generally accessible networks, such as an Internet, parties interested in executing a brand awareness advertising campaign, or otherwise interested in awareness of brands and changes in awareness over time, looked to various data sources generated by the network and users therein. Yet monitoring resources within the network (a form of “media monitoring” for mentions of brands or words and phrases associated with a brand), even though it is amenable to automation, is becoming increasingly complex as the number and variety of channels that information can be shared increases: by way of non-limiting example, web sites, blogs, social networks, email, Skype communications, instant messaging, file sharing, chat sessions, etc.

In certain embodiments, monitoring of brand awareness may measure more than explicit user actions intending to communicate to other users resources which include words or phrases associated with a brand or the brand name itself, and brand awareness may be monitored and measured whether or not such communication is public in nature. Communications posted on network resources such as websites and social media communications such as Facebook or Twitter, are explicit. Yet most engagement with network resources and sharing of network resources or elements within the network resources, is through copy/paste activities associated with Email or other non-public channels. Further, certain engagements, such as a user electing to copy an element within a network resource, may not precipitate a sharing or communication of that element to another party, and is therefore completely invisible in conventional systems.

Certain embodiments of the present invention measure changes in brand awareness, engagement, recognition, or contemplation through the monitoring and collection of implicit user interactions with elements within a network resource, identifying the presence of words and phrases generally associated with a brand, or the presence of the brand itself within the element. Further, words and phrases within the element subject to an implicit user interaction may be used to provide general sentiment towards the brand, and such provision maybe made using and suitable means and techniques generally known to one skilled in the art.

Although the present invention is not limited to implementations with a particular network resource user interaction detection system, in some embodiments the detection system capable of identifying and communicating user interactions with a network resource may maintain the occurrence of, content of, and/or particular terms contained within any text elements subject to a user interaction as part of the user interaction detection (Relevant User Interaction Information or “RUII”) separate from the user computing device, with at least one computing device acting as a centralized server. The central server may receive a query from a client program executed by a user computing device, wherein the query may contain, at a minimum, the URL of the network resource being viewed on the user computing device. The central server may then respond to the query as to whether there exist RUII associated with the URL of the network resource. The benefits of this particular structure, in particular with the method and system for increasing relevance of search results within a network, is the ability to collate, collect, or scan RUII from a multiplicity of users with at least one computing device acting as a centralized service provider.

In certain embodiments, the user interaction detection system is based upon a RUII server in network communication with a user computing device, whereby the RUII server receives RUII from a client software application running on the user's computing device. The system may store the RUII of a user, optionally together with formatting information which may localize the user interaction within the network resource, on a RUII server separate from the web server hosting the network resource.

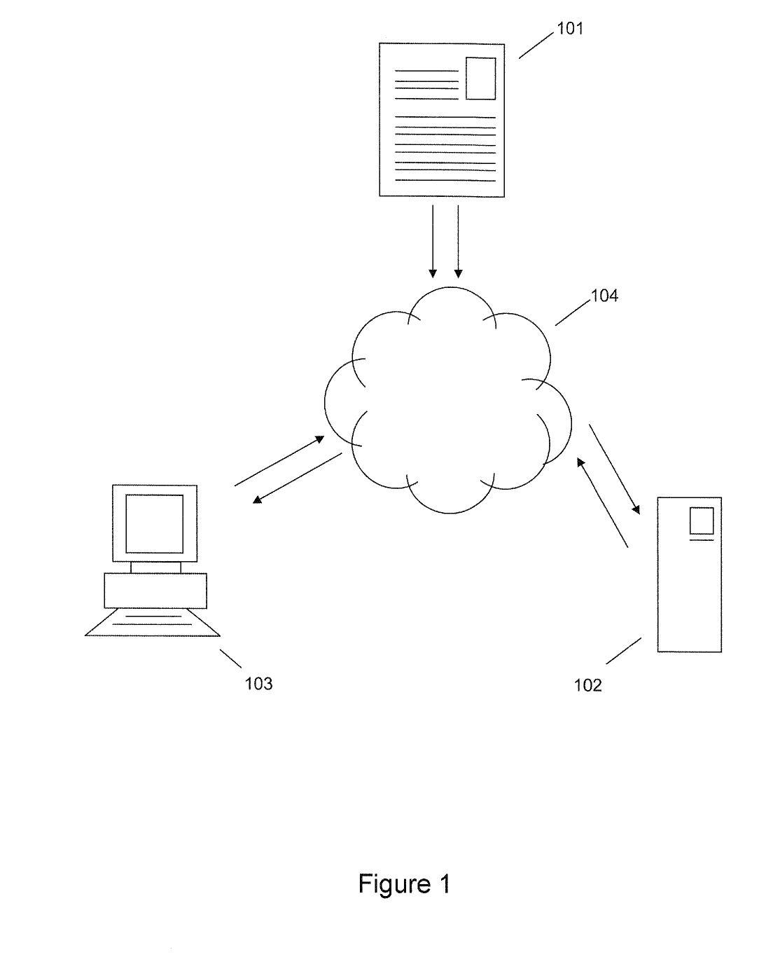

FIG. 1 shows a schematic of the relationship between user computing device 103 containing user interaction detection client software, and RUII server 102, wherein a portion of a network resource 101 (e.g., a web page) is subject to a user interaction by the user on user computing device 103. Users may interact with a variety of network resources, including application specific documents, video content, audio content and/or databases. The communication between user computing device 101, RUII server 102 and network resource 101 may be through a network 104 (e.g., the Internet). In certain embodiments of the user interaction detection system described herein, the RUII server 102 communicates with user computing device 103 through a client program within user computing device 103, where the client program is in network communication with RUII server 102.

The user interaction detection software may be resident on the user computing device, operating either in conjunction with a program or in an environment within a program capable of accessing and displaying network resources and interpreting and effecting computing device-readable instructions, including, but not limited to instructions written in Java®, JavaScript, or programming instruction languages particular to a certain web browser, etc. Installation of the user interaction detection software may be by a user such that the software is normally resident upon the computing device and is available to the user upon each use of the software capable of accessing or displaying user network resources (e.g., a web browser).

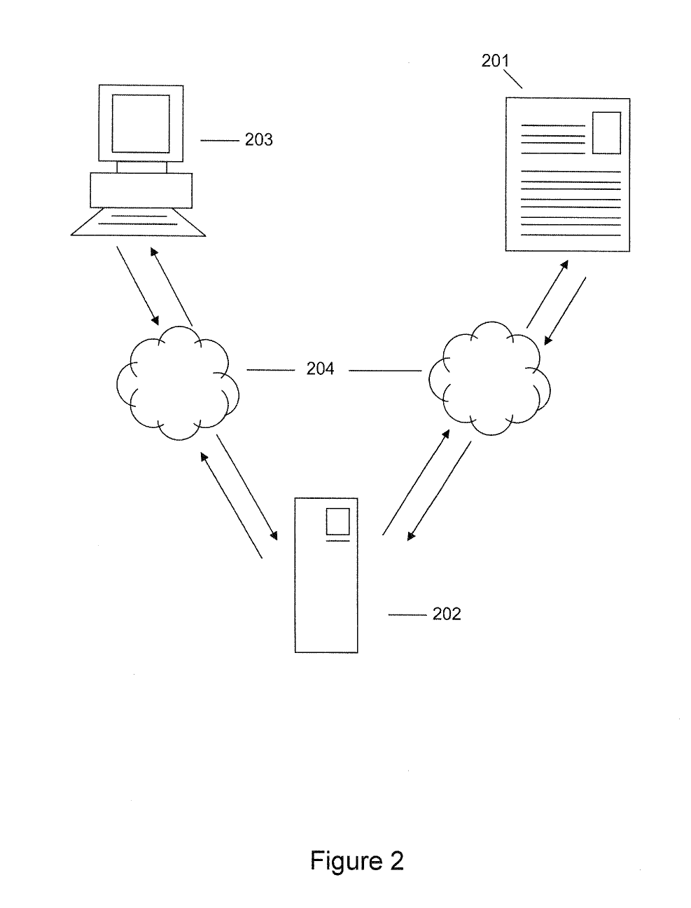

In certain embodiments, the user interaction detection software may be delivered by means of a network proxy, as depicted in FIG. 2. In this example, the user interaction detection client software may run within the network browser environment (e.g., via JavaScript), and may be loaded on a per-page basis using a proxy server. In this embodiment, user computing device 203 may seek access to network resource 201, wherein the access to network resource 201 is routed through proxy server 202, with proxy server 202 accessing network resource 201. User computing device 203, network resource 201 and proxy server 202 all may be in network communication through means of a common network 204 (e.g., the Internet). Network resource 201 may be obtained by proxy server 202 and passed on to user computing device 203, together with computing device software code capable of interpretation and operation within the user computing device 203. The software code when executed implements the processes and functions described and contemplated as the present invention, specifically the detection of user interactions with a network resource and communication of RUII as more fully described herein.

In some embodiment, proxy server 202 may only communicate user interaction detection software code prior to, or following, transmission of the originally requested network resource 201. The user interaction detection software may then be executed within the program operating on user computing device 203 that is responsible for the accessing and display of network resource 201.

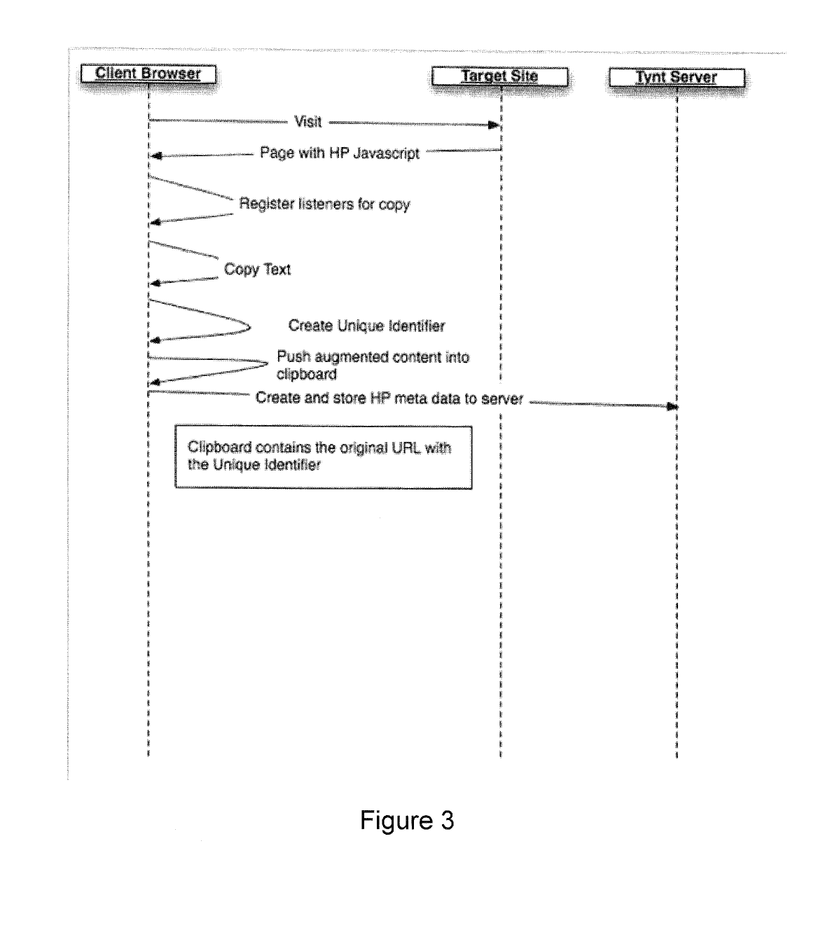

FIG. 3 illustrates an embodiment of the communication process by which the client software present on the user computing device (“Client Browser”) may provide information on user interactions to the RUII server. Each network resource may carry with it a unique page identifier, for example a URL, which may be used for cataloguing RUII associated with the network resource. As the network resource is accessed on the user computing device, client software (Client Browser) may communicate the page identifier to the RUII server, optionally together with a unique identifier code for the user computing device, or alternatively for the client software (user ID). Software code capable of being executed on the user computing device or within a program on the user computing device, such as a client browser, for implementing for altering and reporting the occurrence of the user interactions contemplated by the present invention (“HP Javascript”) may be provided by the network accessible computing device providing the network resource (“Network Resource Provider”) as presented in FIG. 3. Alternatively, the HP Javascript may be obtained from a computing device other than the Network Resource Provider, including the RUII Server or other network accessible computing device (not pictured) via a direction given by the Network Resource Provider to the Client Browser.

Optionally, information (“supplemental information”) may be communicated to the client for presentation to the client through the client browser. Supplemental information may include general information thought to be of relevance to the particular network resource being viewed, an annotation associated with the network resource, or a given user ID. In certain embodiments, supplemental information may be an advertisement expected to be relevant to the user. In an alternative embodiment, supplemental information may be a link to an alternative network resource. Following the user interaction, if optional supplemental information has been received by the client, the supplemental information may be rendered together with the network resource for the user to view. Further, the substance and form of the supplemental information may be determined by the RUII, under direction of the RUII server or another computing device in network communication with the user computing device.

The various systems, modules, etc. described herein may each include a storage component for storing machine-readable instructions for performing the various processes as described and illustrated. The storage component may be any type of machine-readable medium (i.e., one capable of being read by a machine) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine readable (computing device-readable) storing medium. Each computing device or system may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms.

Categorizing Users within a Network Environment

As noted, no central authority exists for cataloguing the hundreds of millions of network resources, such as HTML pages, files or media available within an intranet or the Internet. Information or resources of interest may be found within a network using a directory hierarchy and/or search engine. Within a directory hierarchy a web page may be analyzed and categorized, allowing users to scan through various categories, and associated subcategories, to identify resources of interest. Alternatively, a search engine may provide a dataset of terms and phrases (keywords) upon which a user may query, and may return a listing of web resources associated with the keywords. Search engines include Google®, Yahoo® and Alta Vista® search engines. Analyzing and categorizing of web pages may be a very resource and time intensive task, and can be further complicated by the dynamic nature of web pages being created, modified and deleted by the publishers or managers of the web pages. For parties without the resources and computing facilities of the large search engines, understanding the content of a given page can be a challenge.

In particular, advertisers who are interested in presenting advertising to users viewing a web page which is relevant to that user. One method of providing relevant advertising content is to correlate the ads presented to the content of the page. In this situation, the web page can be manually viewed and categorized, though more likely is for an advertiser to parse the web page using an automated process to identify key words or content which is then categorized, and the advertising presented is based upon that categorization or the underlying keywords. Advertisers may seek to understand the user who accesses the web page, rather than understand the web page the user accesses. One means of doing this is by use of a “search retargeting” in which the search terms a user inputs as part of the user's query to a search engine is used to build a historical perspective of terms the user is interested in. These terms can then be categorized or keywords identified within the historical search terms which are then later used to select advertising which is believed to have increased relevance to the user based upon the user's historical search term use. As search terms are commonly associated with the URL upon a search engines redirection of a user to a given web page, this enables the publishers of web pages to collect and pass on those search terms to third parties who in the aggregate can begin to build a search term history of a user, and with the use of a persistent state token, identify that user at some later time.

Search retargeting is an example of building a historical database of interests of a user, in this case based upon a subset of search terms a user has entered into search engines. Yet the information available to those collecting the search terms is necessarily limited. Search engines are typically able to collect only that information generated by users of the specific search engine though the search engine may have a general understanding of the content of the web page as part of the search engines categorization and analysis. Third parties may gain only a subset of the search engine queries, specifically those search engine results which result in a user being redirected to a web page wherein the URL redirect contains the search terms used and in which the web page publisher is collecting the data. Also, third parties do not generally have the resources necessary to properly analyze and categorize the web page accessed, beyond the search terms used to access that page. Therefore certain aspects of the invention relate to providing an ability to correlate search terms as generally used in search retargeting with additional data gathered on the user's historical interests as well as additional information obtained from the web page the user accessed as part of the search retargeting process.

Certain embodiments of the present invention provide methods and systems for integration of data generated through the detection of user interactions with network resources accessible within an electronic network. Certain embodiments of the invention provide a historical database of search terms entered by a user.

### Search Term Databases

A user's search history may be tracked and monitored without imposing client-side software functionality using a persistent state token maintained by Internet web browsers. The token may be accessible to the unique server on behalf of which the browser created the token. The token may be referred to as a “cookie” or a “Browser Cookie.” A search engine server can place a unique token cookie on a user's browser operating on a computer, and obtain the unique token as part of a user's search process; the search terms entered by the user can then be correlated to the unique token cookie and a historical database of search terms entered through the browser is created. The unique cookie token maintained as part of the web browser may correlate to a particular user.

A user's search history may be tracked when a web publisher's or content provider's server receives a request from a user computer, or intermediate thereof. The request typically contains the referring page URL. In situations where the referral page is a search listing generated by a search engine in response to entry of search terms, the referring URL may contain the search terms. Therefore the server of the web publisher or content provider receives, upon a redirection or link-through from a search result page generated by a search engine, the search terms recently utilized by a user. One or more historical database of search terms for the user may be generated by placing a unique cookie on the user whose referral page is a search result page with an URL that contains the search terms used to generate the search results.

Web publishers or providers of web content not generally providing search engine functions may include a search field within their content, such search field providing search terms input by a user to a search engine for return to the user. As the search field is part of the content of the web publisher or web content provider, it is possible to acquire the search terms of a user. Using cookies in a fashion similar to that described above, a web publisher or web content provider may accumulate a historical database of search terms entered by a user.

Since web publishers or providers of web content are typically limited to collecting information with respect to users accessing the publisher's or provider's network resources, the volume of data and discrete users is limited to those accessing those resources. Therefore, advertising networks, providers of advertising support services, or other parties otherwise providing content to a multiplicity of web publishers or providers of web content, may undertake a similar strategy, providing along with the advertising the ability for a user to conduct a search function. This may significantly increase the number of discrete web pages enabled with the search functions, and therefore increased the number of discrete users capable of providing search terms for a historical database.

This information can be used to enhance the user experience, improve search results returned by the search engine, or to provide advertisers information on the particular user so as to provide the user more relevant advertising or advertising expected to be of more interest to the user. Further, this information may be used to categorize users based on their search histories, these categories or collections of unique users can then be targeted with specific content, advertising or other means. One way these categories may be capitalized upon is to merchandize the discrete categories of users to advertisers with particular interest in providing advertising to those user groups. Other means of utilizing the search history are known in the art, and beyond the scope of the present invention. It is contemplated that any means of identifying, categorizing or bundling users based upon their search histories, as well as any means of collecting the search histories, is applicable to the present invention.

User Interactions with a Web Page

Certain embodiments of the present invention are broadly applicable to a variety of systems and are not limited to any particular programming language. For the purposes of this discussion only, descriptions will generally refer to embodiments of the invention using the JavaScript™ programming language, which is highly prevalent in many commercially available Internet browsers. In certain embodiments, for example, a system comprises combinations of hardware and software. Software code is typically communicated proximate in time with, or concurrent with, the communication to a second computer of a network resource located on a first computer. For example, a web page may facilitate this communication whereby the code contains one or more functions according to certain aspects of the invention (described in more detail below). The network resource can comprise digital content of various types.

In certain embodiments, the code contemplated by the present invention can be executed proximate in time to the provision of a display based, and/or including the network resource on the first computer. The display may be provided using a viewing program capable of viewing the network resource including, for example, a web browser. The execution of the code can provide a copy command intercept program operating on the first computer that is capable of interacting with the viewing program. The copy command intercept program is configured to alter the normal process of copy command application within at least the viewing program.

Upon selection of a copy command by the user (a “copy event”) a copy command intercept program causes elements selected for copying to be transmitted into the user's copy/paste memory buffer of the second computer with additional content appended into the memory buffer such additional content being defined by a manager or administrator of the first computer. Optionally, the copy command intercept program reports copy events to at least one other computer in network communication with the second computer, the copy event information stored in a database for analysis. The copy event information typically comprises identification of the copied content (and/or the copied content itself), the URL of the original article, the IP address/geographic location of the browser performing the copying, and/or other information generally known in the art as useful for identifying relevance of information to a user. This information is then used to by the web page manager/administrator to better understand which network resources, or elements within a particular network resource are popular, frequently copied or of increased relevance to the user.

In certain embodiments, the additional content may be pasted as well when the user pastes the content subject to a copy event. Statistics can be generated for the web site manager/administrator for a variety of purposes, including assisting with the attribution of content, providing a better understanding of which elements of a network resource are interacted with by a user and how often, and correlating user interactions with frequency of access of network resources.

In certain embodiments of the present invention, software code is communicated proximate in time, or concurrent with, the communication to a second computer of a network resource located on a first computer to a second computer. The network resource may include, for example, a web page and the code can include instructions that cause a computer to perform at least some of the functions provided according to certain aspects of the invention and described in more detail below. The network resource typically comprises digital content.

The code can be executed proximate in time to the network resource display on the first computer using a viewing program capable of viewing a network resource, such as a web browser. As a result, a detection computer program operating on the first computer is capable of interacting with the viewing program, whereby the detection program can identify user interactions with a network resource by means of a user interaction detection program.

When the user interacts with the network resource, the user interaction identification program typically causes the communication—from the second computer to the first computer, and/or to a third computer—of the occurrence of a user interaction with the network resource. Additional information may be communicated including
information identifying the URL of the network resource;
the internet address of the second computer;
the time of user interaction with the network resource;
elements within the network resource that are subject of a user interaction;
metatags associated with the network resource;
the Title of the network resource;
certain HTML tags associated with the network resource, including but not limited to “<HEAD>”, “<TITLE>”, “<LEGEND>” “<MENU>”, and “<THEAD>”; and
the URL associated with a user selecting a hyperlink to a second network resource within the first network resource.

A user interaction with the network resource can include the copying of, the selection of, and/or the printing of certain elements forming part of the network resource and/or can include the copying of the URL of the network resource. In some embodiments, information can be obtained and communicated independent of, or in the absence of, explicit user interactions with the network resource, by way of non-limiting example, a user undertaking a copy action.

The user interaction communicated to the first computer or third computer may be stored in a database for analysis. This information can then be used by the web page manager/administrator to better understand which content is popular, which is frequently copied and/or which content is of increased relevance to the user. Statistics can be generated for the web site manager/administrator for a variety of purposes, including assisting with the attribution of content, providing a better understanding of which elements of a network resource are interacted with by a user and how often, and correlating user interactions with frequency of access of network resources.

According to certain aspects of the invention, the interaction of a user with a webpage can include the copying of, selection of and/or printing of certain elements forming part of the network resource. The interaction of a user with a webpage can also include copying the URL of the network resource. As used herein “selection of” with respect to certain elements forming part of a network resource means a user interaction with a network resource such that a portion of the network resource is displayed differently to a user than the remainder. For example, programs capable of viewing a network resource, such as internet browsers, allow the selection of text by the user which results in the modification of the display of the text to the user. In one example colors of the text and its surrounding area may be inverted (e.g. white to black, black to white, etc.).

The detection of the copying of an URL may be implemented by various means. Typically, detection of copy events outside of the program environment of the network resource viewer (e.g., a browser) requires implementation within the operating system of the user computer. Though possible, this presents a number of challenges, including interception of such programs by virus detection and protection software. In some embodiments, an ID can be uniquely generated on each access of the network resource by a user and inserted in the URL of a network resource which includes the user interaction detection software. Insertion can be made without otherwise interfering with accessing of the network resource by browsers and other programs. The URL which includes the uniquely generated ID can be detected by the computer hosting the network resource if the URL is used at some later time, and can then be correlated with a past access. Thus, the act of copying of an URL is not monitored, but the act of a user utilizing a copied URL is registered. In some embodiments, the uniquely generated URLs may include as part of the URL an encoded measure of the time of the unique URL generation or the internet address of the user accessing the network resource. Such means of encoding may include using a reversible function, or other means including means that are known in the art. A database of uniquely URLs may be maintained, where the URLs are correlated to an encoded measure of the time of the unique URL generation or the internet address of the user accessing the network resource.

A historical database of user interactions with a web page may be generated using one or more unique cookie tokens queried prior to, during or following an a user accessing a web page communicating modules, agents or code to the user computer. This historical database may be more robust and contain more information on the network resources accessed, as well as the elements within the network resource interacted with by the user, than that currently existing in the art. As the number of network resources communicating the code, modules and/or agents described herein increases, the historical database generated may also increase, both in the number of discrete users identified as well as the data collected with respect to each.

### Merger of the Databases

As described herein, the benefits of maintaining a historical database of search terms for unique visitors has numerous benefits. One skilled in the art will recognize that the additional information provided by identifying the content within a web page subject to user interactions, or keywords present therein, provides substantial improvements over conventional systems and methods. The inclusion of the user interactions with a web page, in addition to the historical search terms, in a database provides the ability to categorize a unique user based upon their explicit (search terms) and implicit (user interactions with a web page) with network resources which they have accessed or sought to access.

Though unique cookies may be specific to a browser and a particular server establishing the cookie, certain embodiments communicate information associated with a common user between servers and cookies. Certain embodiments may provide cookies, collect search terms used by a user, and monitor and receive user interactions with a web page using a single server or, if desired, through a multiplicity of servers. The historical database of search terms that may pre-exist can be merged with a developing, or already developed, database of user interactions with a web page based upon cookie sharing methods and systems including suitable methods and systems that are known in the art.

The utility of such a database will be appreciated by one skilled in the art. Such uses include, but are not limited to:
presentation of advertising to a user accessing a network resource, based upon keywords or categories generated within the database;
identification of sets of users based upon data corresponding to the user within the database;
identification of users to a third party in real-time or in close temporal proximity to the users accessing certain network resources, based upon data corresponding to the user within the database;
presentation of content to a user accessing a network resource, based upon keywords or categories generated within the database;
electing not to present certain advertising to a user accessing a network resource, based upon keywords or categories generated within the database;
electing not to present certain content to a user accessing a network resource, based upon keywords or categories generated within the database;
offering access to certain network resources to a user accessing a network resource, based upon keywords or categories generated within the database;
electing not to offer access to certain network resources to a user accessing a network resource, based upon keywords or categories generated within the database;
identification of certain keywords within the data present in the database, which are correlated with specific activities of a user, or trends associated with the user or group of users.

### System Description

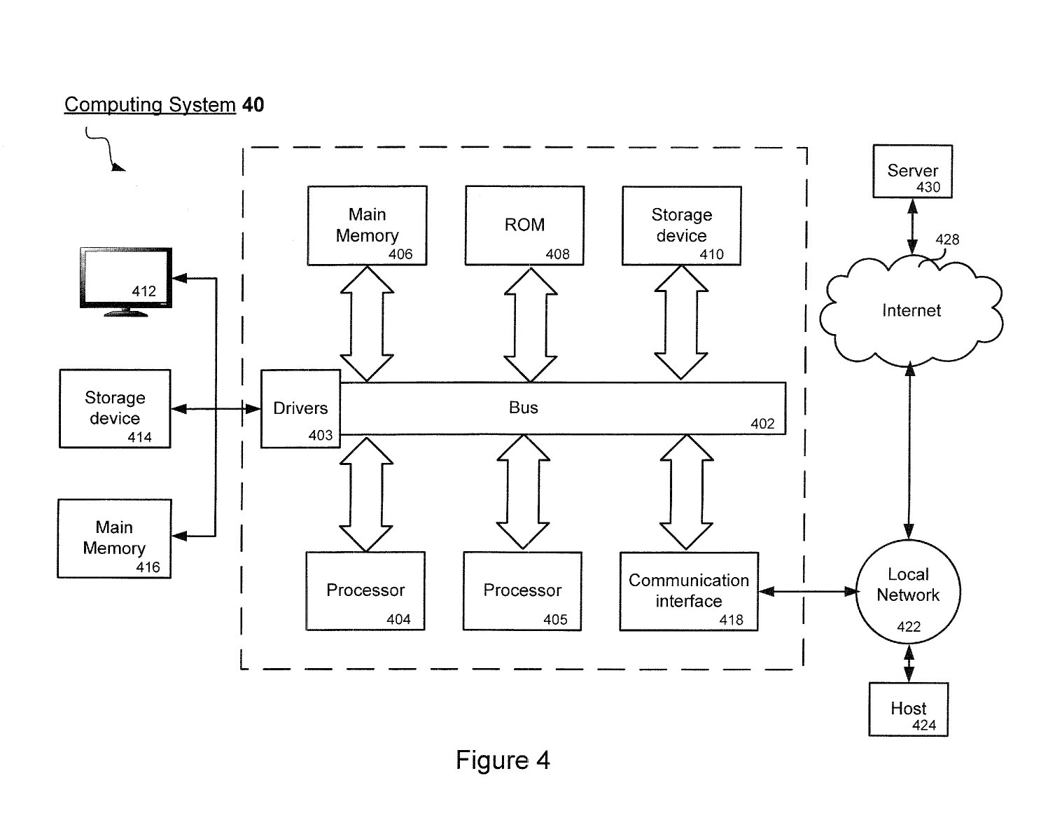

Turning now to FIG. 4, certain embodiments of the invention employ a processing system that includes at least one computing system 400 deployed to perform certain of the steps described above. Computing systems may be a commercially available system that executes commercially available operating systems such as Microsoft Windows®, UNIX or a variant thereof, Linux, a real time operating system and or a proprietary operating system. The architecture of the computing system may be adapted, configured and/or designed for integration in the processing system, for embedding in one or more of an image capture system, a manufacturing/machining system, a graphics processing workstation and/or a . . . . In one example, computing system 400 comprises a bus 402 and/or other mechanisms for communicating between processors, whether those processors are integral to the computing system 40 (e.g. 404, 405) or located in different, perhaps physically separated computing systems 400. Device drivers 403 may provide output signals used to control internal and external components

Computing system 400 also typically comprises memory 406 that may include one or more of random access memory (“RAM”), static memory, cache, flash memory and any other suitable type of storage device that can be coupled to bus 402. Memory 406 can be used for storing instructions and data that can cause one or more of processors 404 and 405 to perform a desired process. Main memory 406 may be used for storing transient and/or temporary data such as variables and intermediate information generated and/or used during execution of the instructions by processor 404 or 405. Computing system 400 also typically comprises non-volatile storage such as read only memory (“ROM”) 408, flash memory, memory cards or the like; non-volatile storage may be connected to the bus 402, but may equally be connected using a high-speed universal serial bus (USB), Firewire or other such bus that is coupled to bus 402. Non-volatile storage can be used for storing configuration, and other information, including instructions executed by processors 404 and/or 405. Non-volatile storage may also include mass storage device 410, such as a magnetic disk, optical disk, flash disk that may be directly or indirectly coupled to bus 402 and used for storing instructions to be executed by processors 404 and/or 405, as well as other information.

Computing system 400 may provide an output for a display system 412, such as an LCD flat panel display, including touch panel displays, electroluminescent display, plasma display, cathode ray tube or other display device that can be configured and adapted to receive and display information to a user of computing system 400. Typically, device drivers 403 can include a display driver, graphics adapter and/or other modules that maintain a digital representation of a display and convert the digital representation to a signal for driving a display system 412. Display system 412 may also include logic and software to generate a display from a signal provided by system 400. In that regard, display 412 may be provided as a remote terminal or in a session on a different computing system 400. An input device 414 is generally provided locally or through a remote system and typically provides for alphanumeric input as well as cursor control 416 input, such as a mouse, a trackball, etc. It will be appreciated that input and output can be provided to a wireless device such as a PDA, a tablet computer or other system suitable equipped to display the images and provide user input.

According to one embodiment of the invention, portions of the disclosed methods may be performed by computing system 400. Processor 404 executes one or more sequences of instructions. For example, such instructions may be stored in main memory 406, having been received from a computer-readable medium such as storage device 410. Execution of the sequences of instructions contained in main memory 406 causes processor 404 to perform process steps according to certain aspects of the invention. In certain embodiments, functionality may be provided by embedded computing systems that perform specific functions wherein the embedded systems employ a customized combination of hardware and software to perform a set of predefined tasks. Embodiments of the invention are not limited to any specific combination of hardware circuitry and software.

The term “computer-readable medium” is used to define any non-transitory medium that can store and provide instructions and other data to processor 404 and/or 405, particularly where the instructions are to be executed by processor 404 and/or 405 and/or other peripheral of the processing system. Such medium can include non-volatile storage, volatile storage and transmission media. Non-volatile storage may be embodied on media such as optical or magnetic disks, including DVD, CD-ROM and Blu Ray devices. Storage may be provided locally and in physical proximity to processors 404 and 405 or remotely, typically by use of network connection. Non-volatile storage may be removable from computing system 404, as in the example of Blu Ray, DVD or CD storage or memory cards or sticks that can be easily connected or disconnected from a computer using a standard interface, including USB, etc. Thus, computer-readable media can include floppy disks, flexible disks, hard disks, magnetic tape, any other magnetic medium, CD-ROMs, DVDs, Blu Ray, any other optical medium, punch cards, paper tape, any other physical medium with patterns of holes, RAM, PROM, EPROM, FLASH/EEPROM, any other memory chip or cartridge, or any other medium from which a computer can read.

Transmission media can be used to connect elements of the processing system and/or components of computing system 400. Such media can include twisted pair wiring, coaxial cables, copper wire and fiber optics. Transmission media can also include wireless media such as radio, acoustic and light waves. In particular radio frequency (RF), fiber optic and infrared (IR) data communications may be used.

Various forms of computer readable media may participate in providing instructions and data for execution by processor 404 and/or 405. For example, the instructions may initially be retrieved from a magnetic disk of a remote computer and transmitted over a network or modem to computing system 400. The instructions may optionally be stored in a different storage or a different part of storage prior to or during execution.

Computing system 400 may include a communication interface 418 that provides two-way data communication over a network 420 that can include a local network 422, a wide area network or some combination of the two. For example, an integrated services digital network (ISDN) may used in combination with a local area network (LAN). In another example, a LAN may include a wireless link. Network link 420 typically provides data communication through one or more networks to other data devices. For example, network link 420 may provide a connection through local network 422 to a host computer 424 or to a wide area network such as the Internet 428. Local network 422 and Internet 428 may both use electrical, electromagnetic or optical signals that carry digital data streams.

Computing system 400 can use one or more networks to send messages and data, including program code and other information. In the Internet example, a server 430 might transmit a requested code for an application program through Internet 428 and may receive in response a downloaded application that provides for the anatomical delineation described in the examples above. The received code may be executed by processor 404 and/or 405.

### Additional Descriptions of Certain Aspects of the Invention

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Certain embodiments of the invention comprise systems, methods and devices configured to perform the methods, for monitoring user interactions with keywords associated with a brand or words and phrases within the brand, present within a network resource. Some of these embodiments comprise a first computing device configured to communicate with a network, wherein the first computing device maintains a network resource. Some of these embodiments comprise a second computing device configured to communicate with the network. Some of these embodiments comprise an agent that is provided to the second computing device concurrently with the network resource and that is configured to capture one or more implicit interaction by a user with elements of the network resource when at least a portion of the network resource is displayed on the second computing device.

In some of these embodiments, information associated with the implicit interaction is communicated to one of the first computing device and a third computing device configured to analyze the information for the presence of one or more words corresponding to branded materials. In some of these embodiments, the information comprises at least one of a universal resource locator, a title associated with the network resource, a metatag associated with the network resource, and information provided by a search engine referral or redirect initiated based on the implicit interaction. In some of these embodiments, the information comprises one or more hyperlinks followed by the user. In some of these embodiments, the information comprises information identifying advertising interacted with by the user.

Certain embodiments provide system, methods, and devices for performing methods, for enhancing user experience related to access of a network resource. Some of these embodiments comprise maintaining a first historical database of search terms used by a user of a network resource. Some of these embodiments comprise maintaining a second historical database of interactions of the user with a web page. Some of these embodiments comprise merging the first and second databases to obtain a use history of the user. Some of these embodiments comprise employing the use history to select content to be provided to the user when the user accesses the network resource.

In some of these embodiments, maintaining the first historical database includes generating the first historical database based on a search term used by the user. In some of these embodiments, maintaining the first historical database includes generating the first historical database based on a search term used by the user. In some of these embodiments, the interactions with a web page include implicit interactions. In certain embodiments, the implicit interactions are incomplete interactions that lack at least one actual or affirmative action of the user.

In some of these embodiments, a non-volatile storage medium is encoded with data and instructions that, when executed by one or more processors, cause the one or more processors to perform the steps of a method for enhancing user experience related to access of a network resource and/or for monitoring user interactions with keywords associated with a brand or words and phrases within the brand, present within a network resource.

While particular embodiments of the present invention have been described in the foregoing, it is to be understood that other embodiments are possible within the scope of the invention and are intended to be included herein. It will be clear to a person skilled in the art that modifications of, and adjustments to, this invention, not shown, are possible without departing from the spirit of the invention as demonstrated through the exemplary embodiments. The invention is therefore to be considered limited solely by the scope of the appended claims.

What is claimed is:

1. A system for monitoring user interactions with keywords associated with a brand or words and phrases within the brand, present within a network resource comprising:
a first computing device configured to communicate with a network, wherein the first computing device maintains a network resource;
a second computing device configured to communicate with the network; and
an agent that is provided to the second computing device concurrently with the network resource and that is configured to capture one or more implicit interaction by a user with elements of the network resource when at least a portion of the network resource is displayed on the second computing device,
wherein information associated with the implicit interaction is communicated to one of the first computing device and a third computing device configured to analyze the information for the presence of one or more words corresponding to branded materials.

2. The system of claim 1, wherein the information comprises at least one of a universal resource locator, a title associated with the network resource, a metatag associated with the network resource, and information provided by a search engine referral or redirect initiated based on the implicit interaction.

3. The system of claim 1 wherein the information comprises one or more hyperlinks followed by the user.

4. The system of claim 1 wherein the information comprises information identifying advertising interacted with by the user.

5. A method for enhancing user experience related to access of a network resource, comprising
maintaining a first historical database of search terms used by a user of a network resource;
maintaining a second historical database of interactions of the user with a web page;
merging the first and second databases to obtain a use history of the user; and
employing the use history to select content to be provided to the user when the user accesses the network resource.

6. The method of claim 5, wherein maintaining the first historical database includes generating the first historical database based on a search term used by the user.

7. The method of claim 5, wherein maintaining the first historical database includes generating the first historical database based on a search term used by the user.

8. The method of claim 5, wherein the interactions with a web page include implicit interactions.

9. The method of claim 5, wherein the implicit interactions are incomplete interactions that lack at least one actual or affirmative action of the user.
